(19) United States
(12) Patent Application Publication
(10) Pub. No.: US 2025/0063130 A1
(43) Pub. Date: Feb. 20, 2025

(54) METHOD AND APPARATUS OF IMAGE PROCESSING, ELECTRONIC DEVICE, AND STORAGE MEDIUM

(71) Applicant: Beijing Zitiao Network Technology Co., Ltd., Beijing (CN)

(72) Inventor: Jiabin Huang, Beijing (CN)

(21) Appl. No.: 18/721,177

(22) PCT Filed: Dec. 13, 2022
(86) PCT No.: PCT/CN2022/138760

§ 371 Date: Jun. 17, 2024

(30) Foreign Application Priority Data
Dec. 17, 2021 (CN) 202111552501.7

(51) Int. Cl. H04N 5/262; G06T 7/12; G06V 10/25

(52) U.S. Cl. CPC H04N 5/2621; G06T 7/12; G06V 10/25

(57) ABSTRACT

The disclosure provides a method and apparatus of image processing, an electronic device, and a storage medium. The method of image processing includes: collecting, in response to an effect addition instruction, an image to be processed including a target object; segmenting the image to be processed based on an image segmentation model to obtain at least two target render regions corresponding to the image to be processed; and obtaining, based on the at least two target render regions and an effect parameter, a target image including the target object with an added target effect.

### CROSS-REFERENCE TO RELATED APPLICATION(S)

The disclosure claims the priority to Chinese Patent Application No. 202111552501.7, filed with the Chinese Patent Office on Dec. 17, 2021, which is incorporated herein in its entirety by reference.

### FIELD

The disclosure relates to the technical field of image processing, and relates to, for example, a method and apparatus of image processing, an electronic device, and a storage medium.

### BACKGROUND

With the advancement of short video technology, users become increasingly demanding in terms of diversity of short video contents. In view of this, corresponding effects are added to shooting objects.

The effects are mainly processed through a generative adversarial network (GAN) neural network, for example, a neural network corresponding to a hair dyeing effect. Hence, numerous hair dyeing effects are indispensable for training a corresponding model.

However, since hair styles and hair dyeing effects vary among different users, samples obtained are vary accordingly, resulting in inaccuracy of the model trained. Further, in consideration of diverse hair dyeing effects, it is inevitable that numerous models are trained for different hair dyeing effects due to poor universality of the models.

### SUMMARY

The disclosure provides a method and apparatus of image processing, an electronic device, and a storage medium, so as to achieve authenticity and diversity of effect display.

In a first aspect, the disclosure provides a method of image processing. The method includes: collecting, in response to an effect addition instruction, an image to be processed including a target object; segmenting the image to be processed based on an image segmentation model to obtain at least two target render regions corresponding to the image to be processed; and obtaining, based on the at least two target render regions and an effect parameter, a target image including the target object with an added target effect.

In a second aspect, the disclosure further provides an apparatus of image processing. The apparatus includes: an image collection module configured to collect, in response to an effect addition instruction, an image to be processed including a target object; a render region determination module configured to segment the image to be processed based on an image segmentation model to obtain at least two target render regions corresponding to the image to be processed; and a target image determination module configured to obtain, based on the at least two target render regions and an effect parameter, a target image including the target object with an added target effect.

In a third aspect, the disclosure further provides an electronic device. The electronic device includes: one or more processors; and a memory storing one or more programs, where the one or more processors, when executing the one or more programs, are caused to implement the method of image processing described above.

In a fourth aspect, the disclosure further provides a storage medium. The storage medium includes computer-executable instructions which, when executed by a computer processor, implement the method of image processing described above.

In a fourth aspect, the disclosure further provides a computer program product. The computer program product includes: a computer program embodied on a non-transitory computer-readable medium, where the computer program includes program codes configured to execute the method of image processing described above.

### BRIEF DESCRIPTION OF THE DRAWINGS

FIG. 1 is a schematic flowchart of a method of image processing according to Example 1 of the disclosure;

FIG. 2 is a schematic diagram of an ear render effect according to Example 1 of the disclosure;

FIG. 3 is a schematic flowchart of a method of image processing according to Example 2 of the disclosure;

FIG. 4 is a schematic flowchart of a method of image processing according to Example 3 of the disclosure;

FIG. 5 is a schematic structural diagram of an apparatus of image processing according to Example 4 of the disclosure; and

FIG. 6 is a schematic structural diagram of an electronic device according to Example 5 of the disclosure.

### DETAILED DESCRIPTION OF EMBODIMENTS

Examples of the disclosure will be described below with reference to accompanying drawings. Although some examples of the disclosure are shown in the accompanying drawings, the disclosure can be implemented in various forms, and these examples are provided for understanding the disclosure. The accompanying drawings and the examples of the disclosure are merely illustrative.

A plurality of steps described in a method embodiment of the disclosure can be executed in different orders and/or in parallel. Further, the method embodiment can include an additional step and/or omit a shown step, which does not limit the scope of the disclosure.

As used herein, the terms “comprise” and “include” and their variations are open-ended, that is, “comprise but not limited to” and “include but not limited to”. The term “based on” indicates “at least partially based on”. The term “an example” indicates “at least one example”. The term “another example” indicates “at least another one example”. The term “some examples” indicates “at least some examples”. Related definitions of other terms will be given in the following description.

The concepts such as “first” and “second” mentioned in the disclosure are merely used to distinguish different apparatuses, modules or units, rather than limit an order or interdependence of functions executed by these apparatuses, modules or units.

Modifications with “a”, “an” and “a plurality of” mentioned in the disclosure are schematic rather than limitative, and should be understood by those skilled in the art as “one or more” unless otherwise indicated in the context.

Names of messages or information exchanged among a plurality of apparatuses in the embodiment of the disclosure are merely used for illustration rather than limitation to the scope of the messages or information.

### Example 1

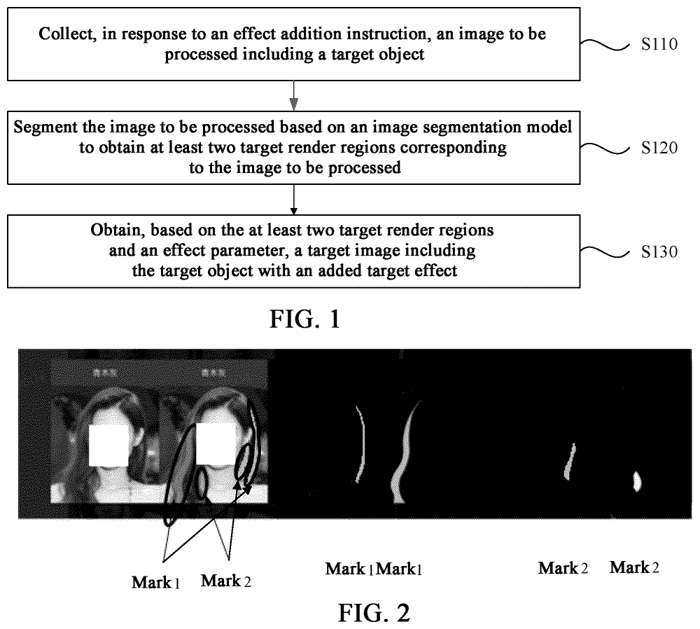

FIG. 1 is a schematic flowchart of a method of image processing according to Example 1 of the disclosure. The example of the disclosure is applied to a situation that an effect is added to a corresponding object in an image and the effect added is caused to best fit the object in any scenario of image display or video shooting supported the Internet. This method may be executed through an apparatus of image processing. This apparatus may be implemented in the form of software and/or hardware, for example, an electronic device. The electronic device may be a mobile terminal or a personal computer (PC) terminal, a server, etc. Any image display scenario is usually implemented through cooperation between a client and the server. The method according to this example may be executed by the server, the client or the client cooperating with the server.

As shown in FIG. 1, the method includes:

S110. In response to an effect addition instruction, an image to be processed including a target object is collected.

An application scenario may be illustratively described at first. The technical solution of the disclosure may be applied to any picture requires effect display, for example, effect display in a video call, or effect display of a streamer user in a live streaming scenario. The technical solution may also be used for effect display of an image corresponding to a photographed user in a process of video shooting, such as in a short video shooting scenario. The technical solution may also be used in a case that an effect is added to a user in a still shot image.

The apparatus for executing the method of image processing according to the example of the disclosure may be integrated in application software supporting an image processing function. The software may be installed in the electronic device. For example, the electronic device may be the mobile terminal, the PC terminal, etc. The application software may be software of one type that processes the image or video as long as the image or video can be processed, which will not be repeated one by one herein.

When the user needs to add an effect during short video shooting, a live stream or shooting of an image including a target object, a display interface may include a button for adding the effect. For example, when the user triggers an effect button, at least one effect to be added may pop up, and the user may select one effect from a plurality of effects to be added as a target effect. Alternatively, after detecting that a control corresponding to effect addition is triggered, the server may determine to add a corresponding effect to the object in a shot frame. In this case, the server or the client may respond to an effect addition instruction and collect the image to be processed including a target object. The image to be processed may be an image collected based on the application software, or an image that is consistent with the effect addition instruction and collected when the effect addition instruction is triggered. The image may include an object to which the effect needs to be added. The object to which the effect needs to be added is taken as the target object. For example, if a hair style of the user is changed or hair of the user is dyed, the target object may be the user. If a hair color of a kitten or a puppy is changed as a whole, then the kitten and the puppy may be the target objects. For example, when it is necessary to change a hair color of the photographed user in a live streaming scenario or video shooting scenario, an image including the user is shot as the image to be processed. In this case, a camera device may collect images to be processed that include a target object from a target scenario in real time or at intervals after the effect addition instruction is triggered.

In an example, the step that in response to an effect addition instruction, an image to be processed including a target object is collected includes: in response to detecting a wake word that triggers addition of an effect to the target object, the effect addition instruction is generated and the image to be processed including a target object is collected. Alternatively, in response to detecting that an effect addition control is triggered, the effect addition instruction is generated and the image to be processed including a target object is collected. And alternatively, in response to detecting that a visual field includes the target object, the image to be processed including a target object is collected.

In a live stream scenario, for example, a livestreaming marketing or video shooting, voice information of a streamer user or a photographed object may be collected, and analyzed and processed. Then, text corresponding to the voice information is recognized. If the text corresponding to the voice information includes the preset wake word, for example, “Please turn on an effect function”, effect display of the streamer or the photographed object is needed, and the image to be processed including a target object may be collected. That is, the target object triggers the effect addition wake word in this case, and a corresponding effects provided by the technical solution may be added to the target object. For example, the effect added may be a hair dyeing effect of the target object. With the hair dyeing effect, a hair color of the target object is not replaced with a color to be displayed as disclosed in the related art. The effect addition control may be a button that may be displayed on the display interface of the application software. When this button is triggered, the image to be processed needs to be collected and effect processing is performed on the image to be processed. When the user triggers this button, an image effect display function is to be triggered. In this case, the image to be processed including a target object may be collected. For example, if the user triggers the effect addition control in the case of an application in a still image shooting scenario, collection of the image to be processed including a target object may be automatically triggered. In the application scenario, for example, in a pantomime video scenario, a facial feature in the image to be used that is collected may be analyzed and processed in real time. A feature detection result of each part in the facial image may be obtained as a feature to be detected. If the feature to be detected matches a preset feature, for example, at least one feature triggering effect display of each part is preset, and when a corresponding feature is triggered at one part, an effect addition instruction may be generated, and the image to be processed is collected. Alternatively, when it is detected that the shot frame includes the target object, image collection is triggered. The image to be processed including a target object may be collected.

When it is necessary to collect in real time the target object from the target scenario, for example, the live stream or image processing scenario, the image may be collected in real time, and the image collected in this case may be taken as the image to be used. The image to be used may be analyzed and processed accordingly. If an analysis result satisfies specific requirements, the image to be used may be taken as image to be processed when the specific requirements are satisfied.

The technical solution may be implemented by the client or the server in a case that each video frame in the video is processed after video shooting is completed and then is sent to the client for being displayed, or a case that video frames shot are processed in turn during the video shooting. In the case, each video frame is the image to be processed

S120. The image to be processed is segmented based on an image segmentation model to obtain at least two target render regions corresponding to the image to be processed.

The image segmentation model is a pre-trained neural network model. If it is necessary to determine the render region in the image to be processed, a plurality of samples to be trained (the samples to be trained are images to be trained) may be obtained. A plurality of regions in each training sample may be marked, for example, by selecting, in a box shape, a plurality of regions in the training image. The image to be trained is used as an input parameter of the to-be-trained image segmentation model, and an image including a marked region is used as an output of the image segmentation model. Based on the image to be trained in the sample to be trained and a corresponding marked region in the image, the image segmentation model may be trained. A number of the at least two target render regions may be two, three or more. The render regions correspond to corresponding marked regions of the image in the sample to be trained of the image segmentation model.

The image to be processed may be input into the pre-trained image segmentation model. Based on the image segmentation model, a plurality of render regions in the image to be processed may be determined, and the plurality of render regions determined in this case are taken as the target render regions.

The input of the image segmentation model may be the image to be processed, and the output of the model may be images of render regions determined of a current image to be processed. The image segmentation model is the neural network, and this network may be in a structure of visual geometry group network (VGG), residual networks (ResNet), GoogleNet, MobileNet, ShuffleNet, etc. For different network structures, computation amounts of different network structures vary and not all models are lightweight. That is, some models that have a large computation amount are not suitable to deploy on the mobile terminal. A model that has a small computation amount, high computation efficiency and simplicity is easier to deploy on the mobile terminal. If this technical solution is implemented based on the mobile terminal, a model structure of MobileNet or ShuffleNet may be used. According to a principle of the model structure, traditional convolution is changed into separable convolution, that is, depthwise convolution and point-wise convolution, in order to reduce the computation amount. In addition, inverted residuals are used to improve a feature extraction capacity of depthwise convolution. In addition, a simple operation of a shuffle channel is also used to improve an expression capacity of the model. Basic module design of the model is described above, and the model is basically formed by stacking the above modules. This type of model is less time-consuming in reasoning, and may be applied to a terminal with a high time-consuming requirement. Any one of the neural networks described above may be used on a server as long as the render of the image to be processed can be determined. The image segmentation model is merely described above, but not limited thereto.

In the example of the disclosure, the step that the image to be processed is segmented

based on an image segmentation model to obtain at least two target render regions corresponding to the image to be processed includes: based on the image segmentation model, the target object in the image to be processed is segmented, and a bounding box region corresponding to the target object, and at least one render region to be processed are determined. The at least two target render regions are determined based on the bounding box region and the at least one render regions to be processed.

In this example, the at least two target render regions are ear render regions, and the bounding box region is a region surrounding hair of the target object.

In the technical solution, the effect added to the target object may be a hair dyeing effect, in order to make the hair dyeing effect best fit a real scenario or personalized needs of the user. For example, it is necessary to determine a dyeing effect of each color, or a dyeing effect of each color in a corresponding region, which may be determined based on the technical solution. The ear render region may take an edge line of an ear as a boundary of image segmentation. A region below the boundary and close to a face is taken as an inside ear render region. A region above the boundary and relatively far away from the face is taken as an outside ear render region. As shown in FIG. 2, the region corresponding to Mark 1 denotes the outside ear render region, and the region corresponding to Mark 2 denotes the inside ear render region. The bounding box region may be a region corresponding to the hair of the target object. Mark 1 indicates left and right outside ear render regions, and Mark 2 indicates left and right inside ear render regions.

The image segmentation model may segment the image to be processed input, and determine a region to which an effect is to added in the image to be processed. The region to which an effect is to added is taken as the render region to be processed. In an actual application, there is a problem that the render region to be processed segmented by the image segmentation model is not located on the hair, that is, a region segmented is inaccurate. In this case, a region initially segmented based on the image segmentation model may be taken as the render region to be processed. The render region to be processed may be filtered based on the bounding box region, and a region that actually needs to be rendered and is located on the hair is obtained. That is, the target render region is obtained.

The image to be processed may be segmented based on the image segmentation model, so as to obtain a plurality of render regions to be processed. In order to determine whether the render region to be processed is located on the hair, the render region to be processed may be filtered based on the bounding box region, and a render region to be processed inside the bounding box region may be used as the target render region.

S130. Based on the at least two target render regions and an effect parameter, a target image including the target object with an added target effect is obtained.

Based on the description above, the target render region includes a plurality of ear render regions in the hair. The effect parameter may be a pre-selected parameter that requires adding a corresponding effect to the target render region. An image determined after the effect is added to the target render region is taken as the target image. The effect added based on the effect parameter is taken as the target effect accordingly. For example, the target effect may be a color effect.

An effect parameter is determined when a triggering operation is determined, for example, bleaching color information. The bleaching color information is added to the target render region determined, and the target image including the target object with an added target effect is obtained.

In an example, the step that based on the at least two target render regions and an effect parameter, a target image including the target object with an added target effect is obtained includes: a target pixel value of each pixel in the at least two target render regions is determined based on the effect parameter. An original pixel value of the pixel in the at least two target render regions is updated based on the target pixel value of the pixel point to obtain the target image including the target object with an added target effect.

Each pixel of the image displayed has a corresponding pixel value. For example, three channels of red-green-blue (RGB) have corresponding values, and values in the three channels may be replaced with values corresponding to corresponding bleaching colors (effect parameters). Then, the target image including the target object with an added target effect is obtained. The pixel value of the pixel in the target render region in the image to be processed is taken as the original pixel value. The pixel value corresponding to the effect parameter is taken as the target pixel value. The original pixel value may be replaced with the target pixel value.

There may be many bleaching colors, for example, gray-white gradient colors. Then, target pixel values of different pixels are also different, and the target pixel value matches the effect parameter.

In an example, the step that based on the at least two target render regions and an effect parameter, a target image including the target object with an added target effect is obtained includes: the at least two target render regions are rendered based on a rendering model and the effect parameter to obtain the target image including the target object with an added target effect.

The rendering model may be the pre-trained neural network and is configured to process the effect parameter and determine the target pixel value corresponding to the effect parameter, or process the target render region into a region matching the effect parameter.

After the at least two target render regions are determined, the effect parameter and the image that includes the target render regions may be used as the input of the rendering model. Based on this rendering model, an image rendered that matches the effect parameter may be output, and the image obtained in this case may be used as the target image including the target object with an added target effect.

The technical solution may be applied to any scenario requiring local rendering, and then, a schematic diagram of a local rendering effect is obtained.

According to the technical solution of the example of the disclosure, the image to be processed including a target object may be collected under the condition of detecting that the effect addition instruction is triggered. The target render region in the image to be processed is determined based on the image segmentation model, the target effect is added to the target object based on the target render region and the effect parameter, and the target image is obtained. Thus, the problem in the prior art that neural networks corresponding to different rendering methods need to be trained, and a large number of training samples are further needed to be obtained besides training of a large quantity of training samples, resulting in inconvenient rendering effect addition is solved. The neural network merely needs to determine the render region to be processed, and then the corresponding effect is added to the render region, such that convenience of effect processing is improved and high adaptability to actual use is achieved.

### Example 2

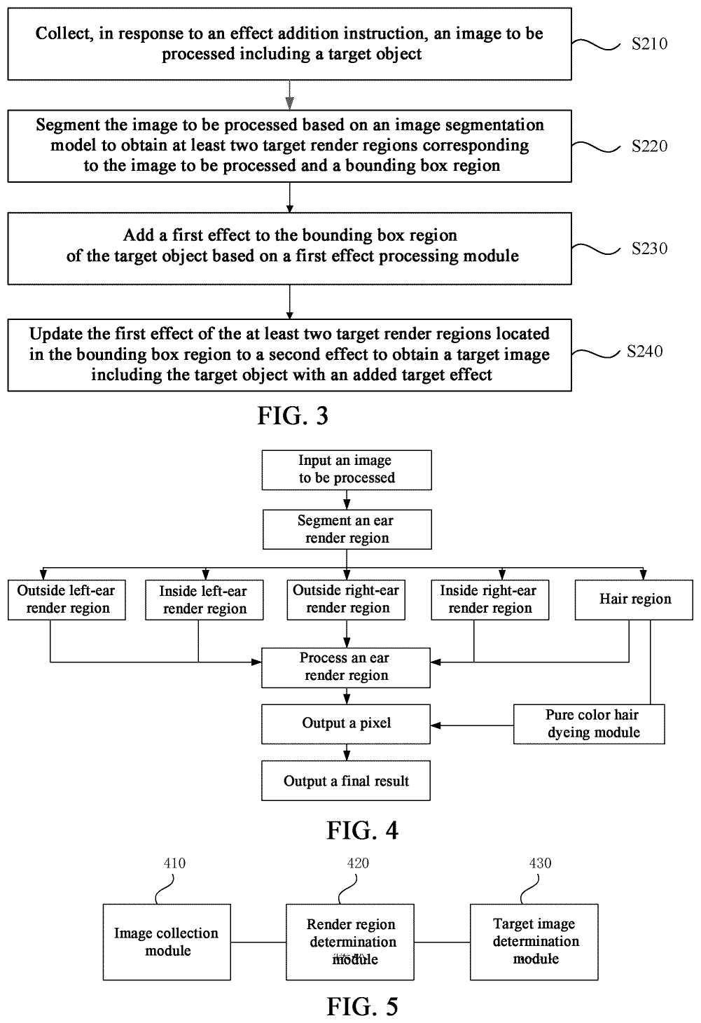

FIG. 3 is a schematic flowchart of a method of image processing according to Example 2 of the disclosure. Based on the foregoing example, a case that a plurality of effects need to be added to a target object exists and may be implemented based on this technical solution. Reference can be made to the description of this technical solution for an embodiment. Technical terms that are the same as or corresponding to those in the example described above are not repeated herein.

As shown in FIG. 3, the method includes:

S210. In response to an effect addition instruction, an image to be processed including a target object is collected.

S220. The image to be processed is segmented based on an image segmentation model to obtain at least two target render regions corresponding to the image to be processed, and a bounding box region.

S230. A first effect is added to the bounding box region of the target object based on a first effect processing module.

The first effect may be an effect that needs to be added to the entire bounding box region. The first effect processing module may be a first effect addition model, that is, a pre-trained neural network. Based on an effect parameter, the first effect may be added to the entire bounding box region. The first effect may be a pure color effect, for example, an effect of dyeing entire hair yellow.

Based on the first effect processing module, an effect, corresponding to the first effect, in the effect parameter may be added to the bounding box region of the target object.

S240. The first effect of the at least two target render regions located in the bounding box region is updated to a second effect, and a target image including the target object with an added target effect is obtained.

The second effect may be an effect superimposed on the target render region or an effect for updating the target render region. For example, if it is necessary to add gray bleaching in the target render region, that is, an ear render region, then the gray bleaching may be updated in the target render region.

While the first effect is added to the bounding box region, the second effect may be added to the target render region. The first effect and the second effect may be superposed in the target render region, or the target render region may merely include a second rendering effect. A corresponding image after effect addition is taken as the target image, and a final effect image may be seen in FIG. 2.

Based on the technical solution described above, the method further includes: in response to detecting that an operation of replacing the first effect is triggered, the second effect keeps unchanged and the first effect according to the triggering operation is updated. In response to detecting that an operation of replacing the second effect is triggered, the first effect keeps unchanged and the second effect according to the triggering operation is updated.

According to the technical solution of the example of the disclosure, the image to be processed including a target object may be collected under the condition of detecting that the effect addition instruction is triggered. The target render region in the image to be processed is determined based on the image segmentation model, the target effect is added to the target object based on the target render region and the effect parameter, and the target image is obtained. Thus, the problem in the prior art that neural networks corresponding to different rendering methods need to be trained, and a large number of training samples are further needed to be obtained besides training of a large quantity of training samples, resulting in inconvenient rendering effect addition is solved. The neural network merely needs to determine the render region to be processed, and then the corresponding effect is added to the render region, such that convenience of effect processing is improved and high adaptability to actual use is achieved.

### Example 3

FIG. 4 is a schematic flowchart of a method of image processing according to Example 3 of the disclosure. Technical terms that are the same as or corresponding to those in the example described above are not repeated herein.

As shown in FIG. 4, a current image to be processed is input into an image segmentation model, and an ear render region is processed. An outside left-ear render region, an inside left-ear render region, an outside right-ear render region, an inside right-ear render region and a hair region that includes hair are obtained. That is, at least two target render regions may be the foregoing outside left-ear render region, inside left-ear render region, outside right-ear render region and inside right-ear render region. The hair region is the bounding box region mentioned above.

Each pixel in the ear render region output by the image segmentation model may have a corresponding value, for example, within a range of 0 to 1. The value is used to indicate whether the pixel is located in the ear render region.

In this example, the ear render region may be processed as follows: an ear render region may also be segmented in a non-hair region in a segmentation result of the image segmentation model, and then the four ear render regions may be filtered separately by the hair region. That is, the ear render region is constrained based on the hair area, and the ear render region shall be located in the hair region. When an ear render effect becomes strong and weak from time to time since some pixel values (within 0-1) output by the ear render region after filtration are not very high, the ear render region may be post-processed by a method as follows: the pixel value in the ear render region is increased. In general, in a curve stretching manner, a pixel value less than 0.1 is forced to equal 0, and a pixel value greater than 0.9 is forced to equal 1, such that a weaker pixel point value equals directly 0, and a stronger pixel point value equals directly 1. Then, four ear render regions well processed are obtained, that is, the foregoing target render regions.

After a number of usable ear render regions are obtained, a hair dyeing effect may be added to the ear render regions. In an actual application, hair dyeing and ear render may exist at the same time. In this case, new bleaching color is added to the ear render region based on pure color dyeing of hair.

In a possible embodiment, after the ear render region is obtained, a color of the ear render region needs to be replaced in two methods. The first method is as follows: an RGB value of the ear render region is replaced with a value of the corresponding bleaching color based on a traditional method. A second method is as follows: hair in the ear render region is bleached pure color based on a pre-generated neural network model. In this case, merely data of different colors of hair are needed to train the model, and training a bleaching model with samples corresponding to different hair lengths, different hair styles and different colors is avoided, thus reducing difficulty of obtaining training data.

A final effect may be obtained by superimposing a segmentation result of the above ear render region on a result of a pure color hair dyeing module. In addition, an ear render capacity may be reused to a great extent, and new effects may be obtained merely by changing different bleaching pure colors. Original image/ear render effect image/pure gold hair image/pure dark color image/ear render mask.

According to the technical solution of the example of the disclosure, the image to be processed may be segmented to obtain left and right ear render regions and outside and inside ear render regions corresponding to the target object in the image to be processed. Then an ear render hair style effect may be obtained by superimposing the hair dyeing colors. A neural network corresponding to a general hair style effect needs to be trained by obtaining a large number of pictures of a target effect. For example, in the case of blond hair bleaching, many pictures of figures with blond hair is required. That is, dyeing different colors of hair requires training different hair dyeing models. In addition, ear render is a highly personalized hair style, and there are few sample data corresponding to ear render images. In addition, hair styles corresponding to ear render may be varied and colorful. It is difficult to collect corresponding effect images accordingly. Even if a large number of ear render images that satisfy effect requirements are collected, and a corresponding neural network is trained, one neural network model may only achieve one effect. If it is necessary to achieve ear render effects in different colors, and training different models is required, such that reusability is low, and a lot of workload is increased. However, in the technical solution, an ear render effect can be specified in any color, a corresponding ear render effect can be obtained merely by training one image segmentation model, and merely a used ear dyeing color needs to be replaced later. Thus, reusability is high, and the data are very easy to collect, convenience of effect addition is improved, and richness and universality of contents of the effect are further achieved.

### Example 4

FIG. 5 is a schematic structural diagram of an apparatus of image processing according to Example 4 of the disclosure. As shown in FIG. 5, the apparatus includes: an image collection module 410, a render region determination module 420 and a target image determination module 430.

The image collection module 410 is configured to collect, in response to an effect addition instruction, an image to be processed including a target object. The render region determination module 420 is configured to segment the image to be processed based on an image segmentation model to obtain at least two target render regions corresponding to the image to be processed. The target image determination module 430 is configured to obtain, based on the at least two target render regions and an effect parameter, a target image including the target object with an added target effect.

Based on the technical solution described above, the image collection module 410 is configured to in response to detecting a wake word that triggers addition of an effect to the target object, generate the effect addition instruction and collect the image to be processed including a target object; or alternatively, in response to detecting that an effect addition control is triggered, generate the effect addition instruction and collect the image to be processed including a target object; or alternatively, in response to detecting that a visual field includes the target object, collect the image to be processed including a target object.

Based on the technical solution described above, the render region determination module 420 includes: a to-be-processed render region determination unit configured to segment, based on the image segmentation model, the target object in the image to be processed, and determine a bounding box region corresponding to the target object, and at least two render regions to be processed; and a target render region determination unit configured to determine the at least two target render regions based on the bounding box region and the at least two render regions to be processed.

Based on the technical solution described above, the target image determination module 430 includes: a pixel value determination unit configured to determine a target pixel value of each pixel in the at least two target render regions based on the effect parameter; and a pixel value update unit configured to update an original pixel value of the pixel in the at least two target render regions based on the target pixel value of the pixel point to obtain the target image including the target object with an added target effect.

Based on the technical solution described above, the target image determination module 430 is configured to: render the at least two target render regions based on a rendering model and the effect parameter to obtain the target image including the target object with an added target effect.

Based on the technical solution described above, the target image determination module 430 is further configured to: add a first effect that corresponds to the effect parameter to a bounding box region of the target object based on a first effect processing module; and update the first effect of the at least two target render regions located in the bounding box region to a second effect that corresponds to the effect parameter to obtain the target image including the target object with an added target effect; or alternatively, superpose a second effect that corresponds to the effect parameter into the at least two target render regions to obtain the target image including the target object with an added target effect.

Based on the technical solution described above, the apparatus further includes: in response to detecting that an operation of replacing the first effect is triggered, an effect addition module configured to keep the second effect unchanged and update the first effect according to the triggering operation; or alternatively, in response to detecting that an operation of replacing the second effect is triggered, keep the first effect unchanged and update the second effect according to the triggering operation.

Based on the technical solution described above, the at least two target render regions are hair dyeing regions, and the bounding box region is a region corresponding to hair.

According to the technical solution of the example of the disclosure, the image to be processed including a target object may be collected under the condition of detecting that the effect addition instruction is triggered. The target render region in the image to be processed is determined based on the image segmentation model, the target effect is added to the target object based on the target render region and the effect parameter, and the target image is obtained. Thus, the problem in the prior art that neural networks corresponding to different rendering methods need to be trained, and a large number of training samples are further needed to be obtained besides training of a large quantity of training samples, resulting in inconvenient rendering effect addition is solved. The neural network merely needs to determine the render region to be processed, and then the corresponding effect is added to the render region, such that convenience of effect processing is improved and high adaptability to actual use is achieved.

The apparatus of image processing according to the example of the disclosure may execute the method of image processing according to any example of the disclosure, and has corresponding functional modules and effects for executing the method.

A plurality of units and modules included in the apparatus described above are merely divided according to a functional logic, but are not limited to the above division, as long as the corresponding functions can be performed. In addition, names of the plurality of functional unit are merely for the convenience of mutual distinguishing rather than limitation to the protection scope of the example of the disclosure.

### Example 5

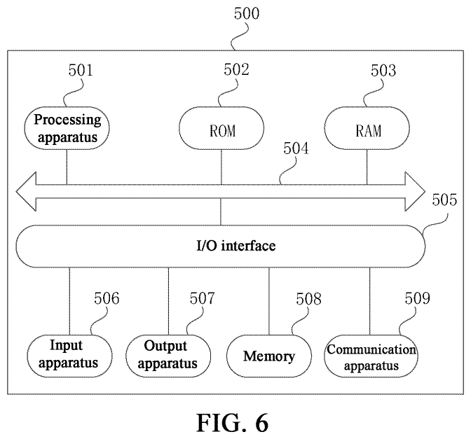

FIG. 6 is a schematic structural diagram of an electronic device according to Example 5 of the disclosure. With reference to FIG. 6, a schematic structural diagram of the electronic device 500 (for example, a terminal device or a server in FIG. 6) applied to implementation of the example of the disclosure is shown. The terminal device in the example of the disclosure may include, but are not limited to, a mobile terminal such as a mobile phone, a laptop, a digital broadcast receiver, a personal digital assistant (PDA), a portable android device (PAD), a portable media player (PMP) and a vehicle-mounted terminal (such as a vehicle-mounted navigation terminal), and a fixed terminal such as a digital television (TV) and a desktop computer. The electronic device 500 shown in FIG. 6 is merely an instance, and should not be constructed as limitation to functions and application scopes of the example of the disclosure.

As shown in FIG. 6, the electronic device 500 may include a processing apparatus 501 (including a central processing unit, a graphics processing unit, etc.) that may execute various appropriate actions and processing based on a program stored in a read-only memory (ROM) 502 or a program loaded from a memory 508 to a random access memory (RAM) 503. The RAM 503 may further store various programs and data required for the operation by the electronic device 500. The processing apparatus 501, the ROM 502, and the RAM 503 are connected to one another through a bus 504. An input/output (I/O) interface 505 is also connected to the bus 504.

Generally, the following apparatuses may be connected to the I/O interface 505: an input apparatus 506 including, for example, a touch screen, a touch pad, a keyboard, a mouse, a camera, a microphone, an accelerometer and a gyroscope, an output apparatus 507 including, for example, a liquid crystal display (LCD), a speaker and a vibrator, the memory 508 including, for example, a magnetic tape and a hard disk, and a communication apparatus 509. The communication apparatus 509 may allow the electronic device 500 to be in wireless or wired communication with other devices for data exchange. Although the electronic device 500 having various apparatuses is shown in FIG. 6, not all the apparatuses shown are required to be implemented or provided. More or fewer apparatuses may be alternatively implemented or provided.

According to the example of the disclosure, a process described above with reference to the flowchart may be implemented as a computer software program. For example, the example of the disclosure includes a computer program product. The computer program product includes a computer program embodied on a non-transitory computer-readable medium, and the computer program includes program codes for executing the method shown in the flowchart. In such an example, the computer program may be downloaded and installed from the network through the communication apparatus 509, or installed from the memory 508, or installed from the ROM 502. When executed by the processing apparatus 501, the computer program executes the above functions defined in the method according to the example of the disclosure.

Names of messages or information exchanged among a plurality of apparatuses in the embodiment of the disclosure are merely used for illustration rather than limitation to the scope of the messages or information.

The electronic device according to the example of the disclosure belongs to the same concept as the method of image processing according to the example described above, reference can be made to the example described above for the technical details not described in detail in this example, and this example has the same effects as the example described above.

### Example 6

An example of the disclosure provides a computer storage medium. The computer storage medium stores a computer program, where the computer program implements the method of image processing according to the example described above when executed by a processor.

The computer-readable medium described above of the disclosure may be a computer-readable signal medium or a computer-readable storage medium or their any combination. For example, the computer-readable storage medium may be, but are not limited to, an electric, magnetic, optical, electromagnetic, infrared, or semiconductor system, apparatus or device, or their any combination. Examples of the computer-readable storage medium may include, but are not limited to, an electrical connection with one or more wires, a portable computer disk, a hard disk, an RAM, an ROM, an erasable programmable read-only memory (EPROM or a flash memory), an optical fiber, a portable compact disc read-only memory (CD-ROM), an optical storage device, a magnetic storage device, or their any suitable combination. In the disclosure, the computer-readable storage medium may be any tangible medium including or storing a program, and the program may be used by or in combination with an instruction execution system, apparatus or device. In the disclosure, the computer-readable signal medium may include a data signal propagated in a baseband or as part of a carrier wave, in which a computer-readable program code is embodied. This propagated data signal may have a plurality of forms, including but not limited to an electromagnetic signal, an optical signal or their any suitable combination. The computer-readable signal medium may further be any computer-readable medium other than the computer-readable storage medium, and the computer-readable signal medium may send, propagate or transmit a program used by or in combination with the instruction execution system, apparatus or device. The program code included in the computer-readable medium may be transmitted by any suitable medium, including but not limited to: a wireless, wire, optical cable, radio frequency (RF) medium, etc., or their any suitable combination.

In some embodiments, a client and a server may communicate by using any network protocol such as the hypertext transfer protocol (HTTP) that is currently known or will be developed in future, and may be interconnected to digital data communication in any form or medium (for example, a communication network). Instances of the communication network include a local area network (LAN), a wide area network (WAN), Internet work (for example, the Internet), an end-to-end network (for example, an adhoc end-to-end network), and any network that is currently known or will be developed in future.

The computer-readable medium may be included in the electronic device, or exist independently without being fitted into the electronic device.

The computer-readable medium embodies one or more programs, and when executed by the electronic device, the one or more programs cause the electronic device to: collect, in response to an effect addition instruction, an image to be processed including a target object; segment the image to be processed based on an image segmentation model to obtain at least two target render regions corresponding to the image to be processed; and obtain, based on the at least two target render regions and an effect parameter, a target image including the target object with an added target effect.

Computer program codes for executing the operations of the disclosure may be written in one or more programming languages or their combinations, and the programming languages include, but are not limited to, object-oriented programming languages such as Java, Smalltalk and C++, and further include conventional procedural programming languages such as “C” language or similar programming languages. The program codes may be completely executed on a computer of a user, partially executed on the computer of the user, executed as an independent software package, partially executed on the computer of the user and a remote computer separately, or completely executed on the remote computer or the server. In the case of involving the remote computer, the remote computer may be connected to the computer of the user through any type of network, including a local area network (LAN) or a wide area network (WAN), or may be connected to an external computer (for example, through the Internet provided by an Internet service provider).

The flowcharts and block diagrams in the accompanying drawings illustrate the architectures, functions and operations that may be implemented by the systems, the methods and the computer program products according to various examples of the disclosure. In this regard, each block in the flowchart or block diagram may represent one module, one program segment, or a part of codes that includes one or more executable instructions for implementing specified logical functions. It should also be noted that in some alternative implementations, the functions indicated in the blocks may occur in an order different than those indicated in the accompanying drawings. For example, two blocks indicated in succession may actually be executed in substantially parallel, and may sometimes be executed in a reverse order depending on the functions involved. It should also be noted that each block in the block diagram and/or flowchart, and a combination of blocks in the block diagram and/or flowchart may be implemented by a specific hardware-based system that executes specified functions or operations, or may be implemented by a combination of specific hardware and computer instructions.

The units involved in the example of the disclosure may be implemented by software or hardware. A name of the unit does not constitute limitation to the unit itself in some case. For example, a first obtainment unit may also be described as “a unit that obtains at least two Internet protocol addresses”.

The functions described above herein may be executed at least in part by one or more hardware logic components. For example, usable hardware logic components of demonstration types include a field programmable gate array (FPGA), an application specific integrated circuit (ASIC), application specific standard parts (ASSP), a system on chip (SOC), a complex programmable logic device (CPLD), etc. in a non-restrictive way.

In the context of the disclosure, a machine-readable medium may be a tangible medium, and may include or store a program that is used by or in combination with the instruction execution system, apparatus or device. The machine-readable medium may be a machine-readable signal medium or a machine-readable storage medium. The machine-readable medium may include, but is not limited to, an electric, magnetic, optical, electromagnetic, infrared, or semiconductor system, apparatus or device, or their any suitable combination. An instance of the machine-readable storage medium may include an electrical connection based on one or more wires, a portable computer disk, a hard disk, an RAM, an ROM, an EPROM or a flash memory, an optical fiber, a CD-ROM, an optical storage device, a magnetic storage device, or their any suitable combination.

According to one or more examples of the disclosure, [Instance 1] provides a method of image processing. The method includes the following steps.

In response to an effect addition instruction, an image to be processed including a target object is collected.

The image to be processed is segmented based on an image segmentation model to obtain at least two target render regions corresponding to the image to be processed.

Based on the at least two target render regions and an effect parameter, a target image including the target object with an added target effect is obtained.

According to one or more examples of the disclosure, [Instance 2] provides the method of image processing. The method further includes the following steps.

The step that in response to an effect addition instruction, an image to be processed including a target object is collected includes:

In response to detecting a wake word that triggers addition of an effect to the target object, the effect addition instruction is generated and the image to be processed including a target object are collected.

In response to detecting that an effect addition control is triggered, the effect addition instruction is generated and the image to be processed including a target object is collected.

In response to detecting that a visual field includes the target object, the image to be processed including a target object is collected.

According to one or more examples of the disclosure, [Instance 3] provides the method of image processing. The method further includes:

The step that the image to be processed is segmented based on an image segmentation model to obtain at least two target render regions corresponding to the image to be processed includes:

Based on the image segmentation model, the target object in the image to be processed is segmented, and a bounding box region corresponding to the target object, and at least two render regions to be processed are determined.

The at least two target render regions are determined based on the bounding box region and the at least two render regions to be processed.

According to one or more example of the disclosure, [Instance 4] provides the method of image processing. The method further includes:

The step that based on the at least two target render regions and an effect parameter, a target image including the target object with an added target effect is obtained includes:

A target pixel value of each pixel in the at least two target render regions is determined according to the effect parameter.

An original pixel value of the pixel in the at least two target render regions is updated based on the target pixel value of the pixel point to obtain the target image including the target object with an added target effect.

According to one or more examples of the disclosure, [Instance 5] provides the method of image processing. The method further includes:

The step that based on the at least two target render regions and an effect parameter, a target image including the target object with an added target effect is obtained includes:

The at least two target render regions are rendered based on a rendering model and the effect parameter to obtain the target image including the target object with an added target effect.

According to one or more examples of the disclosure, [Instance 6] provides the method of image processing. The method further includes:

The step that based on the at least two target render regions and an effect parameter, a target image including the target object with an added target effect is obtained includes:

A first effect that corresponds to the effect parameter is added to a bounding box region of the target object based on a first effect processing module.

The first effect of the at least two target render regions located in the bounding box region is updated to a second effect that corresponds to the effect parameter, and a target image including the target object with an added target effect is obtained.

A second effect that corresponds to the effect parameter is superposed into the at least two target render regions, and the target image including the target object with an added target effect is obtained.

According to one or more examples of the disclosure, [Instance 7] provides the method of image processing. The method further includes:

In response to detecting that an operation of replacing the first effect is triggered, the second effect keeps unchanged and the first effect according to the triggering operation is updated.

In response to detecting that an operation of replacing the second effect is triggered, the first effect keeps unchanged and the second effect according to the triggering operation is updated.

According to one or more examples of the disclosure, [Instance 8] provides the method of image processing. The method further includes:
the at least two target render regions are ear render regions, and the bounding box region is a region surrounding hair of the target object.

In addition, although a plurality of operations are depicted in a particular order, it should not be understood that these operations are required to be executed in the particular order shown or in a sequential order. In certain circumstances, multi-task and parallel processing may be advantageous. Similarly, although a plurality of implementation details are included in the discussion described above, these details should not be construed as limitation to the scope of the disclosure. Some features described in the context of a separate example can be further implemented in a single example in a combination manner. On the contrary, various features described in the context of the single example can be further implemented in a plurality of examples separately or in any suitable sub-combination manner.

1. A method of image processing, the method comprising:
collecting, in response to an effect addition instruction, an image to be processed comprising a target object;
segmenting the image to be processed based on an image segmentation model to obtain at least two target render regions corresponding to the image to be processed; and
obtaining, based on the at least two target render regions and an effect parameter, a target image comprising the target object with an added target effect.

2. The method of claim 1, wherein the collecting, in response to an effect addition instruction, an image to be processed comprising a target object comprises:
in response to detecting a wake word that triggers addition of an effect to the target object, generating the effect addition instruction and collecting the image to be processed comprising a target object; or alternatively,
in response to detecting that an effect addition control is triggered, generating the effect addition instruction and collecting the image to be processed comprising a target object; or alternatively,
in response to detecting that a visual field comprises the target object, collecting the image to be processed comprising a target object.

3. The method of claim 1, wherein the segmenting the image to be processed based on an image segmentation model to obtain at least two target render regions corresponding to the image to be processed comprises:
segmenting, based on the image segmentation model, the target object in the image to be processed, and determining a bounding box region corresponding to the target object, and at least two render regions to be processed; and
determining the at least two target render regions based on the bounding box region and the at least two render regions to be processed.

4. The method of claim 1, wherein the obtaining, based on the at least two target render regions and an effect parameter, a target image comprising the target object with an added target effect comprises:
determining a target pixel value of each pixel in the at least two target render regions based on the effect parameter; and
updating an original pixel value of the pixel in the at least two target render regions based on the target pixel value of the pixel point to obtain the target image comprising the target object with an added target effect.

5. The method of claim 1, wherein the obtaining, based on the at least two target render regions and an effect parameter, a target image comprising the target object with an added target effect comprises:
rendering the at least two target render regions based on a rendering model and the effect parameter to obtain the target image comprising the target object with an added target effect.

6. The method of claim 1, wherein the obtaining, based on the at least two target render regions and an effect parameter, a target image comprising the target object with an added target effect comprises:
adding a first effect that corresponds to the effect parameter to a bounding box region of the target object based on a first effect processing module; and
updating the first effect of the at least two target render regions located in the bounding box region to a second effect that corresponds to the effect parameter to obtain the target image comprising the target object with an added target effect; or alternatively, superposing a second effect that corresponds to the effect parameter into the at least two target render regions to obtain the target image comprising the target object with an added target effect.

7. The method of claim 6, further comprising:
in response to detecting that an operation of replacing the first effect is triggered, keeping the second effect unchanged and updating the first effect according to the triggering operation; or alternatively,
in response to detecting that an operation of replacing the second effect is triggered, keeping the first effect unchanged and updating the second effect according to the triggering operation.

8. The method of claim 1, wherein the at least two target render regions are ear render regions, and the bounding box region is a region surrounding hair of the target object.

9. (canceled)

10. An electronic device, comprising:
at least one processor; and
a memory storing at least one program;
wherein the at least one processor, when executing the at least one program, is caused to implement a method comprising:
collecting, in response to an effect addition instruction, an image to be processed comprising a target object;
segmenting the image to be processed based on an image segmentation model to obtain at least two target render regions corresponding to the image to be processed; and
obtaining, based on the at least two target render regions and an effect parameter, a target image comprising the target object with an added target effect.

11. A non-transitory readable storage medium comprising computer-executable instructions which, when executed by a computer processor, implement a method comprising:
collecting, in response to an effect addition instruction, an image to be processed comprising a target object;
segmenting the image to be processed based on an image segmentation model to obtain at least two target render regions corresponding to the image to be processed; and
obtaining, based on the at least two target render regions and an effect parameter, a target image comprising the target object with an added target effect.

12. (canceled)

13. The electronic device of claim 10, wherein the collecting, in response to an effect addition instruction, an image to be processed comprising a target object comprises:
in response to detecting a wake word that triggers addition of an effect to the target object, generating the effect addition instruction and collecting the image to be processed comprising a target object; or alternatively,
in response to detecting that an effect addition control is triggered, generating the effect addition instruction and collecting the image to be processed comprising a target object; or alternatively,
in response to detecting that a visual field comprises the target object, collecting the image to be processed comprising a target object.

14. The electronic device of claim 10, wherein the segmenting the image to be processed based on an image segmentation model to obtain at least two target render regions corresponding to the image to be processed comprises:
segmenting, based on the image segmentation model, the target object in the image to be processed, and determining a bounding box region corresponding to the target object, and at least two render regions to be processed; and
determining the at least two target render regions based on the bounding box region and the at least two render regions to be processed.

15. The electronic device of claim 10, wherein the obtaining, based on the at least two target render regions and an effect parameter, a target image comprising the target object with an added target effect comprises:
determining a target pixel value of each pixel in the at least two target render regions based on the effect parameter; and
updating an original pixel value of the pixel in the at least two target render regions based on the target pixel value of the pixel point to obtain the target image comprising the target object with an added target effect.

16. The electronic device of claim 10, wherein the obtaining, based on the at least two target render regions and an effect parameter, a target image comprising the target object with an added target effect comprises:
rendering the at least two target render regions based on a rendering model and the effect parameter to obtain the target image comprising the target object with an added target effect.

17. The electronic device of claim 10, wherein the obtaining, based on the at least two target render regions and an effect parameter, a target image comprising the target object with an added target effect comprises:
adding a first effect that corresponds to the effect parameter to a bounding box region of the target object based on a first effect processing module; and
updating the first effect of the at least two target render regions located in the bounding box region to a second effect that corresponds to the effect parameter to obtain the target image comprising the target object with an added target effect; or alternatively, superposing a second effect that corresponds to the effect parameter into the at least two target render regions to obtain the target image comprising the target object with an added target effect.

18. The electronic device of claim 17, further comprising:
in response to detecting that an operation of replacing the first effect is triggered, keeping the second effect unchanged and updating the first effect according to the triggering operation; or alternatively,
in response to detecting that an operation of replacing the second effect is triggered, keeping the first effect unchanged and updating the second effect according to the triggering operation.

19. The electronic device of claim 10, wherein the at least two target render regions are ear render regions, and the bounding box region is a region surrounding hair of the target object.

20. The non-transitory readable storage medium of claim 11, wherein the collecting, in response to an effect addition instruction, an image to be processed comprising a target object comprises:
in response to detecting a wake word that triggers addition of an effect to the target object, generating the effect addition instruction and collecting the image to be processed comprising a target object; or alternatively,
in response to detecting that an effect addition control is triggered, generating the effect addition instruction and collecting the image to be processed comprising a target object; or alternatively,
in response to detecting that a visual field comprises the target object, collecting the image to be processed comprising a target object.

21. The non-transitory readable storage medium of claim 11, wherein the segmenting the image to be processed based on an image segmentation model to obtain at least two target render regions corresponding to the image to be processed comprises:
segmenting, based on the image segmentation model, the target object in the image to be processed, and determining a bounding box region corresponding to the target object, and at least two render regions to be processed; and
determining the at least two target render regions based on the bounding box region and the at least two render regions to be processed.

22. The non-transitory readable storage medium of claim 11, wherein the obtaining, based on the at least two target render regions and an effect parameter, a target image comprising the target object with an added target effect comprises:
determining a target pixel value of each pixel in the at least two target render regions based on the effect parameter; and
updating an original pixel value of the pixel in the at least two target render regions based on the target pixel value of the pixel point to obtain the target image comprising the target object with an added target effect.
